(19) United States
(12) Patent Application Publication
(10) Pub. No.: US 2019/0331501 A1
(43) Pub. Date: Oct. 31, 2019

(54) METHOD AND DEVICE FOR PLANNING ROUTE, SERVER AND ROBOT

(71) Applicant: CLOUDMINDS (SHENZHEN) HOLDINGS CO., LTD., Shenzhen (CN)

(72) Inventors: Bin WANG, Shenzhen (CN); Song GUO, Shenzhen (CN)

(21) Appl. No.: 16/347,106

(22) PCT Filed: Nov. 3, 2016
(86) PCT No.: PCT/CN2016/104440

§ 371 Date: Jul. 12, 2019

(51) Int. Cl. G01C 21/34; H04B 17/318; H04W 4/029; G01C 21/20; G05D 1/02

(52) U.S. Cl. CPC G01C 21/3461; H04B 17/318; G05D 1/0276; G01C 21/20; G05D 1/0212; H04W 4/029

(57) ABSTRACT

This disclosure relates to a method and a device for planning route, a server and a robot. To satisfy the demand for outbound communication of a robot during its traveling process, in the method, a preset threshold may be preset according to communication quality requirements of communication parties, and then a region where communication signal strength is stronger than the preset threshold is selected out. The selected region is regarded as a route planning basis for route planning, so that communication signal strength on the planned route is stronger than the preset threshold. Thus smooth communication of the robot with the outside in the traveling process based on the planned route is achieved.

### FIELD OF THE INVENTION

This disclosure relates to the communication field, and in particular to a method and a device for planning route, a server and a robot.

### BACKGROUND OF THE INVENTION

Route planning refers to programming a travel path for a mobile object (e.g., a robot, a mobile terminal carried by a user, etc.). If the mobile object itself is a mobile device with the function of route planning, the route planning may be achieved by the mobile device itself. To control the mobile object remotely or reduce power consumption of the mobile object, the mobile object may further request other equipment (e.g., a server) planning route for itself. Either the mobile device or other equipment which route planning is conducted by, it is achieved by a map in related technologies.

The map in related technologies contains geographical location information, so results of the route planning are determined by such a single factor, namely, the geographical location information. However, with the development of communication technology, the demand for outbound communication of the mobile object is strong increasingly. If the mobile object moves according to the results of the route planning provided by related technologies, it may travels to the area where communication signal strength is weak and even travels to the area without communication signal. Thus the interaction with the outside may be influenced and even be suspended.

### SUMMARY OF THE INVENTION

In order to overcome the problems existing in related technologies, this disclosure provides a method and a device for planning route, a computer program product, a non-transitory computer readable storage medium, a server and a robot.

According to a first aspect of embodiments of this disclosure, a method for planning route applied in a server is provided. The method comprises:

acquiring a route planning request sent by a requester side;

planning a route corresponding to the route planning request in a region where communication signal strength is stronger than a preset threshold;

sending the planned route to the requester side.

Optionally, before planning the route corresponding to the route planning request in the region where communication signal strength is stronger than the preset threshold, the method further comprises:

determining the region where communication signal strength is stronger than the preset threshold from a map containing communication signal strength.

Optionally, the method further comprises:

acquiring a geographical location information of a geographical location where the requester side occurred and a communication signal strength of a corresponding geographical location;

building the map containing communication signal strength and corresponding to the requester side in combination with the geographical location information and the communication signal strength;

wherein the process of determining the region where communication signal strength is stronger than the preset threshold from the map containing communication signal strength comprises:

determining the region where communication signal strength is stronger than the preset threshold from the map containing communication signal strength and corresponding to the requester side.

Optionally, the communication signal strength comprises at least one of:

received signal strength indication RSSI, wireless network signal strength, and mobile data network signal strength.

Optionally, the process of acquiring the geographical location information of the geographical location where the requester side occurred and the communication signal strength of the corresponding geographical location comprises:

receiving detection results of communication signal strength sent by the requester side in each geographical location, wherein the detection results of the communication signal strength contain a geographical location information of a geographical location where the requester side is located and communication signal strength of the corresponding geographical location.

According to a second aspect of embodiments of this disclosure, a method for planning route applied in a robot is provided. The method comprises:

determining a region where communication signal strength is stronger than a preset threshold according to a map containing communication signal strength stored in the robot when the robot detects that communication signal strength in its own region is lower than the preset threshold;

planning a first route in the region where communication signal strength is stronger than the preset threshold;

indicating traveling of the robot based on the planned first route.

Optionally, the method further comprises:

searching a region where the robot entered previously on the map containing communication signal strength according to a historical traveling trace on the map containing communication signal strength cached in the robot when the robot detects communication disconnection with a server;

planning a second route according to the region where the robot entered previously and current location of the robot;

indicating traveling of the robot based on the planned second route.

According to a third aspect of embodiments of this disclosure, a device for planning route applied in a server is provided. The device comprises:

a route planning request acquiring module configured to acquire a route planning request sent by a requester side;

a route planning module configured to plan a route corresponding to the route planning request in a region where communication signal strength is stronger than a preset threshold;

a sending module configured to send the planned route to the requester side.

Optionally, the device further comprises:

a determining module configured to determine the region where communication signal strength is stronger than the preset threshold from the map containing communication signal strength.

Optionally, the device further comprises:

a parameter acquiring module configured to acquire a geographical location information of a geographical location where the requester side occurred and a communication signal strength of a corresponding geographical location;

a map building module configured to build the map containing communication signal strength and corresponding to the requester side in combination with the geographical location information and the communication signal strength;

wherein the determining module is configured to determine the region where communication signal strength is stronger than the preset threshold from the map containing communication signal strength and corresponding to the requester side.

Optionally, the communication signal strength comprises at least one of:

received signal strength indication RSSI, wireless network signal strength, and mobile data network signal strength.

Optionally, the parameter acquiring module further comprises:

a receiving submodule configured to receive detection results of communication signal strength sent by the requester side in each geographical location, wherein the detection results of communication signal strength contain a geographical location information of the geographical location where the requester side is located and communication signal strength of the corresponding geographical location.

According to a fourth aspect of embodiments of this disclosure, a device for planning route applied in a robot is provided. The device comprises:

a determining module configured to determine a region where communication signal strength is stronger than a preset threshold according to a map containing communication signal strength stored in the robot when the robot detects that communication signal strength in its own region is lower than the preset threshold;

a first route planning module configured to plan a first route in the region where communication signal strength is stronger than the preset threshold;

a first indicating module configured to indicate traveling of the robot based on the planned first route.

Optionally, the device further comprises:

a searching module configured to search the region where the robot entered previously on the map containing communication signal strength according to a historical traveling trace on the map containing communication signal strength cached in the robot when the robot detects communication disconnection with a server;

a second route planning module configured to plan a second route according to the region where the robot entered previously and current location of the robot;

a second indicating module configured to indicate the traveling of the robot based on the planned second route.

According to a fifth aspect of embodiments of this disclosure, a computer program product is provided. The computer program product contains a computer program executed by a programmable device. The computer program has a code portion for executing the method for planning route above when executed by the programmable device.

According to a sixth aspect of embodiments of this disclosure, a non-transitory computer readable storage medium is provided. The non-transitory computer readable storage medium stores one or more programs, and the one or more programs are used for executing the method for planning route above.

According to a seventh aspect of embodiments of this disclosure, a server is provided, comprising: a non-transitory computer readable storage medium; and one or more processors, used for executing a program in the non-transitory computer readable storage medium; wherein the non-transitory computer readable storage medium stores a command for executing the method for planning route applied in the server above.

According to an eighth aspect of embodiments of this disclosure, a robot is provided, comprising: a traveling drive device, a non-transitory computer readable storage medium; and one or more processors, used for executing a program in the non-transitory computer readable storage medium; and the non-transitory computer readable storage medium stores a command for executing the method for planning route applied in the robot above.

The following beneficial effects may be achieved in the technical solutions provided by the embodiments of this disclosure:

To satisfy the demand for outbound communication of the requester side during its traveling process, the method for planning route provided by this disclosure may be used for presetting a preset threshold according to communication quality requirements of both sides of communication, and then a region where communication signal strength is stronger than a preset threshold is selected out. The selected region is regarded as a route planning basis for route planning, so that the communication signal strength on the planned route is stronger than the preset threshold. Thus smooth communication of the requester side with the outside in the traveling process based on the planned route is achieved. Furthermore, the method for planning route executed by the server is improved by this disclosure. New necessary factors are added in the route planning process: the selected communication signal strength of the multiple regions. That is to say, in the method for planning route provided by this disclosure, not only the geographical location information, but also the communication signal strength of each of the multiple regions where communication signal strength is stronger than the preset threshold are considered. Therefore, the planned route is a result considering geographical location information and communication signal strength comprehensively. Thus smooth communication of the requester side with the outside in the traveling process based on the planned route is achieved.

Other features and advantages of this disclosure will be described specifically in the following specific embodiments.

### BRIEF DESCRIPTION OF THE DRAWINGS

The drawings serve to provide a further understanding of this disclosure, constitute a part of this description and explain this disclosure together with the following specific embodiments, but are not to be construed to limit this disclosure. In the drawings:

FIG. 1 is a schematic view illustrating the structure of an implementing environment involved in embodiments of this disclosure.

FIG. 2 is a flow diagram of a method for planning route applied in a server illustrated according to an exemplary embodiment.

FIG. 3 is a flow diagram of a method for building a map containing communication signal strength illustrated according to an exemplary embodiment.

FIG. 4 is a schematic view of building the map containing communication signal strength illustrated according to an exemplary embodiment.

FIG. 5 is a flow diagram of a method for building a map containing communication signal strength and corresponding to a requester side illustrated according to an exemplary embodiment.

FIG. 6 is a schematic view of building the map containing communication signal strength and corresponding to the requester side illustrated according to an exemplary embodiment.

FIG. 7 is a flow diagram of a method for planning route applied in a server illustrated according to an exemplary embodiment.

FIG. 8 is a block diagram of a device for planning route illustrated according to an exemplary embodiment.

FIG. 9 is another block diagram of the device for planning route illustrated according to an exemplary embodiment.

FIG. 10 is a further block diagram of the device for planning route illustrated according to an exemplary embodiment.

### DETAILED DESCRIPTION OF THE EMBODIMENTS

The specific embodiments of this disclosure will be described in detail in conjunction with the drawings. It should be understood that the specific embodiments described here are used only to describe and explain this disclosure, rather than limit it.

Before describing the method for planning route provided by this disclosure, the application scenario involved in this disclosure is introduced firstly. FIG. 1 is a schematic view illustrating the structure of an implementing environment involved in embodiments of this disclosure. Referring to FIG. 1, the implementing environment may include: a requester side 100 and a server 200, wherein the requester side 100 is a terminal driven by itself for traveling or a terminal carried by a user for traveling, such as, above mobile object (e.g., a robot, a mobile terminal carried by a user, etc.), or an automobile with an automatic drive function is available. The server 200 may include one server, or a server cluster composed of several servers, or may be a cloud computing service center.

The method for planning route provided by this disclosure comprises: a method for planning route applied in the server and a method for planning route applied in the requester side. Firstly, the method for planning route applied in the server provided by this disclosure is described. The method for planning route applied in the server provided by this disclosure is implemented in the region where communication signal strength is stronger than the preset threshold. The preset threshold is set to satisfy the demand for outbound communication of the requester side during its traveling process according to communication quality requirements of both sides of communication. Therefore, it is different from the method for planning route in related technologies. The map in related technologies contains geographical location information, so results of the route planning are determined by such a single factor, namely, the geographical location information, thus influencing and even suspending outbound communication of the requester side. To solve the technical problem, a new method for planning route applied in a server is provided by this disclosure, and then the method for planning route applied in the server provided by this disclosure is described below.

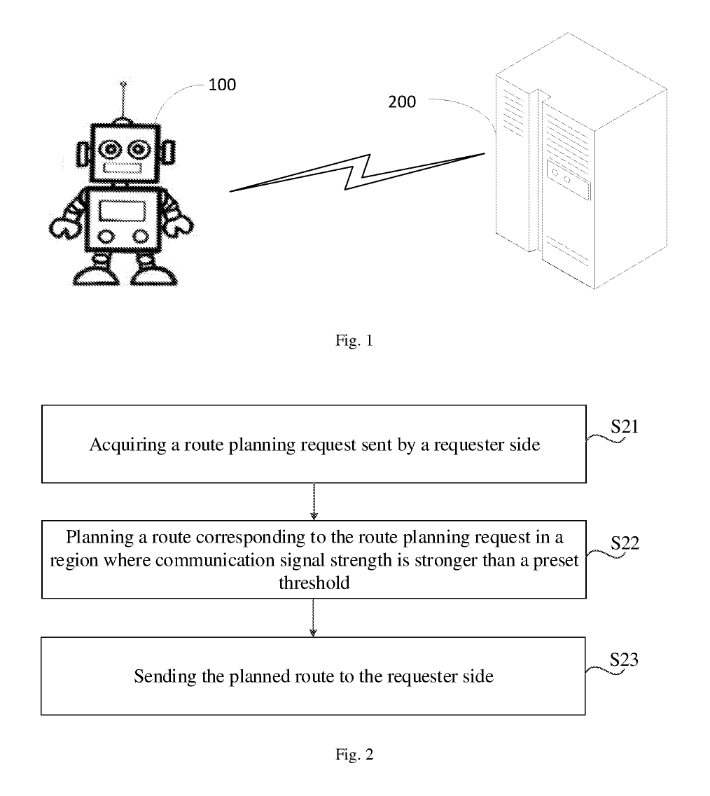

Please referring to FIG. 2. FIG. 2 is a flow diagram of a method for planning route applied in a server illustrated according to an exemplary embodiment. As shown in FIG. 2, the method comprises the following steps:

S21: acquiring a route planning request sent by a requester side;

S22: planning a route corresponding to the route planning request in a region where communication signal strength is stronger than a preset threshold;

S23: sending the planned route to the requester side.

In this disclosure, the requester side is a mobile device for requesting a server for its route planning, such as: a robot, a portable mobile terminal. The requester side sends a route planning request to a server to request the server for its route planning. After receiving the route planning request, the server is triggered by the route planning request to execute the method for planning route applied in the server provided by this disclosure.

To satisfy the demand for outbound communication of the requester side during its traveling process, a preset threshold may be preset according to communication quality requirements of both sides of communication, and then a region where communication signal strength is stronger than the preset threshold is selected out. The selected region is regarded as a route planning basis for route planning, so that the communication signal strength on the planned route is stronger than the preset threshold, thus smooth communication of the requester side with the outside in the traveling process based on the planned route is achieved.

Furthermore, the method for planning route executed by the server is improved by this disclosure. New necessary factors are added in the route planning process: the selected communication signal strength of the multiple regions. That is to say, in the method for planning route provided by this disclosure, not only the geographical location information, but also the communication signal strength of each of the multiple regions where communication signal strength is stronger than the preset threshold are considered. Therefore, the planned route is a result considering geographical location information and communication signal strength comprehensively. Thus smooth communication of the requester side with the outside in the traveling process based on the planned route is achieved.

Optionally, before S22, the method further comprises:

Determining the region where communication signal strength is stronger than the preset threshold from the map containing communication signal strength.

The method for planning route applied in the server provided by this disclosure is implemented by the map containing communication signal strength. It is different from the method for planning route in related technologies. The method for planning route in related technologies is implemented by means of the map in related technologies. Compared with the map in related technologies, besides geographical location information, the map containing communication signal strength includes communication signal strength. Therefore, this disclosure proposes to consider geographical location information and communication signal strength for route planning comprehensively to plan route. For this purpose, the map containing communication signal strength should be built firstly. Hereafter, a method for building the map containing communication signal strength provided in this disclosure is described below.

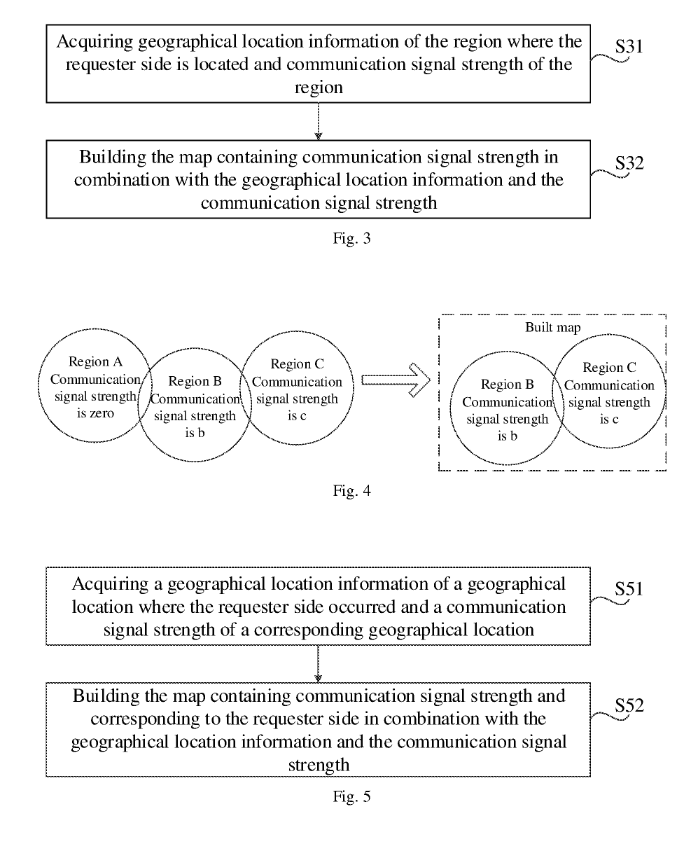

Please referring to FIG. 3. FIG. 3 is a flow diagram of a method for building a map containing communication signal strength illustrated according to an exemplary embodiment. The method as shown in FIG. 3 is applied in a server and comprises the following steps:

S31: acquiring geographical location information of the region where the requester side is located and communication signal strength of the region;

S32: building the map containing communication signal strength in combination with the geographical location information and the communication signal strength.

The requester side is movable relative to the server, due to its mobility. The requester side is located in different regions as time goes by. The requester side has a function of detecting communication signal strength of its own region. The requester side detects communication signal strength of the region when moves to the region. The region in this disclosure may be a geographical range covered by the detection function of the requester side. In addition, the requester side further has a function of positioning geographical location information of its own region.

The requester side may report geographical location information and communication signal strength of its own region to the server when moves every time. The requester side may also report geographical location information and communication signal strength of its own region to the server periodically or irregularly.

Optionally, the step S31 may include the following steps:

Sending a communication signal strength detection command to the requester side, thus indicating the requester side to detect the communication signal strength of the region where the requester side is located;

Receiving a communication signal strength detection response sent by the requester side, wherein the communication signal strength detection response includes the communication signal strength of the region where the requester side is located.

Besides the way of reporting to the server by the requester side, it is feasible that a command is sent by the server to the requester side and responded by the requester side. The server may periodically or irregularly send a communication signal strength detection command to the requester side for indicating the requester side to detect the communication signal strength of its own region. After receiving the command, the requester side positions the region thereof by its positioning function firstly, and the detects the communication signal strength of the region thereof by its detection function. Finally, the requester side carries geographical location information and communication signal strength of the region thereof in a response and sends the response to the server, so that the server acquires geographical location information and communication signal strength of the region where the requester side is located.

After acquiring geographical location information and communication signal strength of every region, the server may build the map containing communication signal strength by means of the two factors, namely, the geographical location information and communication signal strength. Since communication signal strength of every region is considered during map building, compared with the map building of related technologies, more factors are considered in the map building method provided by this disclosure, and such a dimension, the communication signal strength, is added. Therefore, the map built by this disclosure has a wider range of application and is suitable for the mobile object in great demand for outbound communication.

In the process of building the map containing communication signal strength, geographical location information and communication signal strength may be considered simultaneously as well as a variety of building rules may be set. For example, a building rule is that communication signal strength is more than zero, the map built based on the rule is composed of regions with communication signal strength. Regions without communication signal strength will be not included in the map. Another possible building rule is that communication signal strength is more than preset communication signal strength. The map built based on the rule is composed of regions where communication signal strength is more than the preset communication signal strength. Regions where communication signal strength is less than the preset communication signal strength will be not included in the map. Building complexity and decrease the storage space of the built map may be reduced when map is built base on the building rule. The preset communication signal strength may be set manually or preset in a map building device. The building rule may be set manually or preset in a terminal applying the map.

Exemplarily, please referring to FIG. 4. FIG. 4 is a schematic view of building the map containing communication signal strength illustrated according to an exemplary embodiment. The server acquires geographical location information of regions A, B and C respectively. Communication signal strength of regions A, B and C is a, b and c respectively, wherein a is zero, namely, communication signal strength of the region a is zero. In case of the building rule that communication signal strength is more than zero, the built map is as shown in FIG. 4. Communication signal strength of the region A is zero, therefore, it is not included in the built map.

The above-mentioned is the process to build the map containing communication signal strength. The region where communication signal strength is stronger than the preset threshold may be determined from the map containing communication signal strength after the map building. Thus steps S22 and S23 are executed.

Optionally, the method further comprises:

Acquiring a geographical location information of a geographical location where the requester side occurred and a communication signal strength of a corresponding geographical location;

building the map containing communication signal strength and corresponding to the requester side in combination with the geographical location information and the communication signal strength;

Accordingly, the process of determining the region where communication signal strength is stronger than the preset threshold from the map containing communication signal strength comprises:

Determining the region where communication signal strength is stronger than the preset threshold from the map containing communication signal strength and corresponding to the requester side.

Considering that the map built by the method for building the map containing communication signal strength as shown in FIG. 3 occupies large storage space and covers large area, it is unfavorable for finding out the region where communication signal strength is stronger than the preset threshold rapidly, thus resulting in low efficiency of route planning and decrease of timeliness. Therefore, an individualized map may be customized for a requester side, namely, maps containing communication signals are built for different requester sides. A map containing communication signal strength built for a requester side is called the map containing communication signal strength and corresponding to the requester side. Hereafter, the map containing communication signal strength and corresponding to the requester side is described below.

Please referring to FIG. 5. FIG. 5 is a flow diagram of a method for building a map containing communication signal strength and corresponding to a requester side illustrated according to an exemplary embodiment. The method as shown in FIG. 5 is applied in a server and comprises the following steps:

S51: acquiring a geographical location information of a geographical location where the requester side occurred and a communication signal strength of a corresponding geographical location;

S52: building the map containing communication signal strength and corresponding to the requester side in combination with the geographical location information and the communication signal strength.

Optionally, the step S51 may include the following steps:

Receiving detection results of communication signal strength sent by the requester side in each geographical location, wherein the detection results of the communication signal strength contain a geographical location information of a geographical location where the requester side is located and communication signal strength of the corresponding geographical location.

As mentioned above, the requester side is movable relative to the server. The requester side may record geographical location information of the geographical location where it occurred and detect communication signal strength of the geographical location where it occurred to obtain communication signal strength of the geographical location, and then send detection results of the communication signal strength to the server via the communication with the server, so that the server acquires the geographical location information of the geographical location where the requester side occurred and the communication signal strength of the corresponding geographical location.

Afterwards, the server may build the map containing communication signal strength and corresponding to the requester side according to the geographical location information of the geographical location where the requester side occurred and the communication signal strength of the corresponding geographical location. Thus it can be seen that the building of the map containing communication signal strength and corresponding to the requester side is achieved based on historical journey of the requester side and is free from influencing predetermined journey of the requester side. Moreover, it is easy and swift to create the map containing communication signal strength and corresponding to the requester side in the traveling process of the requester side based on its predetermined journey. Moreover, the built map is correlative to the geographical location where the requester side occurred. Therefore, the built map may show traveling features of the requester side better and be more suitable for route planning of the requester side.

Optionally, the step S52 may include the following steps:

Searching the geographical location where the requester side occurred on an initial map;

Marking communication signal strength of the geographical location where the requester side occurred on the initial map.

In the process of building the map containing communication signal strength and corresponding to the requester side, communication signal strength may be marked correspondingly on the basis of the map in related technologies. As mentioned above, the map in related technologies contains geographical location information and is abbreviated the initial map hereafter. Firstly, the geographical location where the requester side occurred is searched on the initial map, and then communication signal strength of the geographical location where the requester side occurred is marked on the corresponding geographical location.

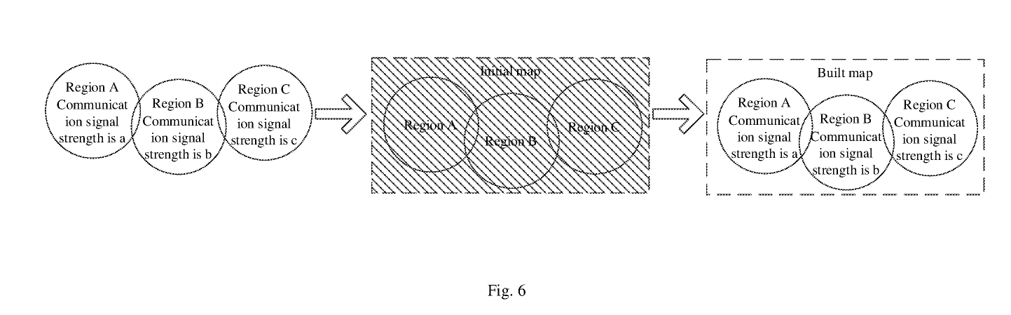

Exemplarily, please referring to FIG. 6. FIG. 6 is a schematic view of building the map containing communication signal strength and corresponding to the requester side illustrated according to an exemplary embodiment. As shown in FIG. 6, the shaded area shows the initial map. It is assumed that the geographical location where the requester side occurred include regions A, B and C, moreover communication signal strength of the regions A, B and C is a, b and c respectively. The regions A, B and C are found firstly, and then the communication signal strength a, b and c is respectively marked on the regions A, B and C of the initial map, thus map building is completed.

The above-mentioned process is the process to build the map containing communication signal strength and corresponding to the requester side. The region where communication signal strength is stronger than the preset threshold may be determined from the map containing communication signal strength and corresponding to the requester side after the map containing communication signal strength is built. Thus steps S22 and S23 are executed.

Optionally, the communication signal strength comprises at least one of:

Received signal strength indication RSSI, wireless network signal strength, and mobile data network signal strength.

In this disclosure, communication signal strength refers to the intensity of the signal for the establishment of communication between two devices. The signal for the establishment of communication between two devices may be: a speech signal, wherein the communication signal strength is RSSI (Received Signal Strength Indication) accordingly. The signal for the establishment of communication between two devices may be: a mobile internet signal, wherein the communication signal strength is the intensity of the mobile data network signal accordingly. The signal for the establishment of communication between two devices may further be: a Wi-Fi signal, wherein the communication signal strength is the intensity of the wireless network signal accordingly.

It can be seen that the method for planning route provided by this disclosure may be implemented by the map containing communication signal strength; to satisfy the demand for outbound communication of the requester side during its traveling process. A preset threshold may be set according to communication quality requirements of both sides of communication, and then the region where communication signal strength is stronger than the preset threshold is selected out from the map containing communication signal strength, and the selected region is regarded as a route planning basis for route planning, so that the communication signal strength on the planned route is stronger than the preset threshold, thus achieving smooth communication of the requester side with the outside in the traveling process based on the planned route.

Furthermore, the method for planning route is improved in this disclosure. New necessary factors are added in the route planning process: the selected communication signal strength of the multiple regions. That is to say, in the method for planning route provided in this disclosure, not only the geographical location information, but also the communication signal strength of each of the multiple regions where communication signal strength is stronger than the preset threshold are considered. Therefore, the planned route is a result considering geographical location information and communication signal strength comprehensively. Thus smooth communication of the requester side with the outside in the traveling process based on the planned route is achieved.

Optionally, information of the starting location is included in the route planning request sent by the requester side at least, and the starting location may the current position of the requester side in this case the requester side request the server for its real-time route planning. The starting location may be other positions different from the current position of the requester side also, in this case the requester side request the server for route planning in advance for the requester side or other terminals.

After receiving the route planning request sent by the requester side, the server firstly finds the starting location from the map containing communication signal strength based on information of the starting location included in the route planning request, thus finding regions around the starting location. And the region where communication signal strength is stronger than the preset threshold is selected by comparing the communication signal strength of regions around the starting location. Then route planning is implemented according to the communication signal strength of the selected regions and the starting location. Finally, the planned route is sent to the requester side, so that the requester side travels based on the planned route. For the explanation of the preset threshold, refer to the text above.

Optionally, the method may include the following steps:

Sequencing communication signal strength of the selected regions from high to low to gain a sequencing result;

Determining that the planned route is a route towards an object region from the starting location according to the sequencing result and the starting location, wherein the object region is the region ranking first or any region ranking ahead of a designated order.

In this disclosure, communication signal strength of the multiple selected regions may be sequenced from high to low after selecting multiple regions by the preset threshold. The region ranking first is regarded as the object region, or it is ranked according to communication quality requirements of both sides of communication to regard any region ranking ahead of the designated order as the object region. Then the planned route is the route towards the object region from the starting location. In this way, the planned route has preferred communication signal strength. It is beneficial for the outbound communication of the requester side.

Exemplarily, the server finds the starting location, namely, a point O from the map containing communication signal strength, and the regions around the point O are regions P, Q, S and T respectively, moreover, communication signal strength of the regions P, Q, S and T is p, q, s and t respectively, wherein p is less than the preset threshold, and q, s, t are all more than the preset threshold. Therefore, the regions Q, S and T are the selected regions. And then, the signal strength q, s and t of the regions Q, S and T are sequenced from high to low. If q>s>t, the region Q is the object region, and the planned route is the route towards the region Q from the point O.

The method for planning route above in the case of a known starting location may be repeated. After planning the route in the known starting location, the requester side travels based on the planned route. The location where the requester side arrives may be regarded as a new starting point, and then the method for planning route may be executed in the case of starting location is known above.

The above-mentioned process is the process of the method for planning route applied in the server provided by this disclosure, and suitable for the case that the server is requested by the requester side for its route planning. In one aspect, if the requester side moves based on results of the route planning in related technologies, the requester side may be stuck in a region with poor communication signal and even a region without communication signal, outbound communication is influenced and suspended even. The reason is as follows: The map in related technologies contains geographical location information, so results of the route planning are determined by such a single factor, namely, the geographical location information, thus outbound communication of the requester side is influenced and suspended even. In another aspect, in case that the requester side has the function of route planning itself, if the map in related technologies is used for route planning of the requester side, the map in related technologies contains geographical location information, so results of the route planning are determined by such a single factor, namely, the geographical location information, thus outbound communication of the mobile object is influenced and suspended even. It can be seen that it is necessary to improve the method for planning route for the requester side. For this purpose, this disclosure further provides a method for planning route applied in a requester side. Hereafter, the method for planning route applied in the server provided by this disclosure is described below.

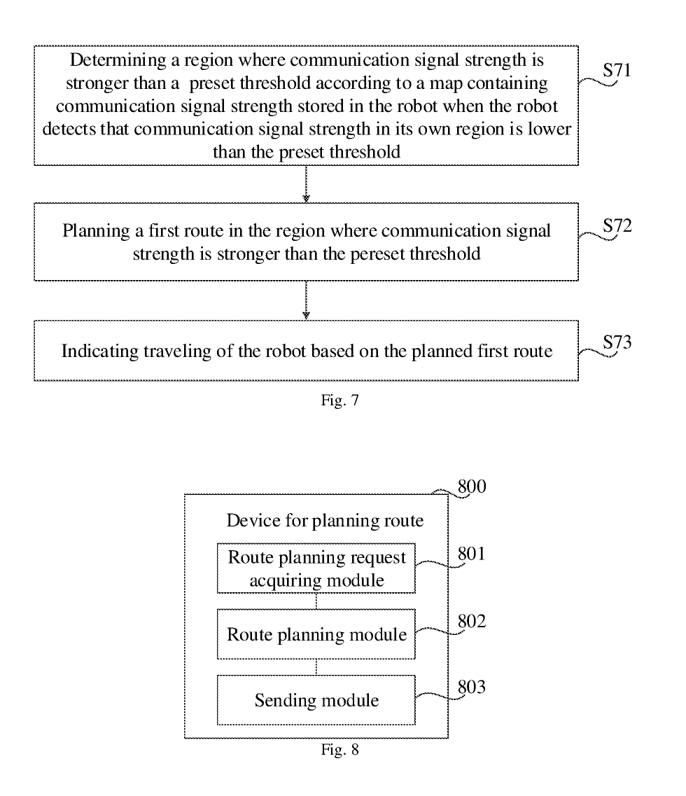

Please referring to FIG. 7. FIG. 7 is a flow diagram of a method for planning route applied in a server illustrated according to an exemplary embodiment. As shown in FIG. 7, the method comprises the following steps:

S71: determining a region where communication signal strength is stronger than a preset threshold according to a map containing communication signal strength stored in the robot when the robot detects that communication signal strength in its own region is lower than the preset threshold;

S72: planning a first route in the region where communication signal strength is stronger than the preset threshold;

S73: indicating traveling of the robot based on the planned first route.

As mentioned above, the requester side has the function of detecting communication signal strength of the region in which it is located. To cope with the situation that the robot moves to the region with poor communication signal strength, and even to the region without communication signal strength, the robot may detect the communication signal strength of the region in which it is located. The robot may detect the communication signal strength of the region in which it is located periodically or irregularly. If the robot detects that the communication signal strength of the region in which it is located is less than the preset threshold, it indicates that the communication signal strength of the region in which it is located is relatively poor, influencing the outbound communication of the robot. For this purpose, the robot may make use of the map containing communication signal strength stored within itself for route planning, so as to walk out the current region with poor communication signal strength and walk into the region with better communication signal strength. The robot makes route planning for itself based on the following method: The region where communication signal strength is stronger than the preset threshold is determined according to the map containing communication signal strength stored in the robot when the robot detects that the communication signal strength of the region in which it is located is lower than the preset threshold. For the specific process, please refer to the process of “determining the region where communication signal strength is stronger than the preset threshold from the map containing communication signal strength” executed by the server, and here there is no more detailed description. And then, the robot plans the first route in the region where communication signal strength is stronger than the preset threshold. Finally, the robot travels based on the planned first route. The method for robot route planning by itself is equivalent to the process that the step S22 in FIG. 2 executed by the server. Therefore, it is not repeated here.

In practical application, the above method for robot route planning by itself and the method for robot route planning by the server may be combined for execution, namely, the robot may plan a route for itself by reference to the planning process executed by the server based on the method for planning route provided by this disclosure, and the robot may plan a route for itself based on the method provided by this disclosure, thus choosing a route both having advantages of geographical location information and communication signal strength.

Optionally, the method may further include the following steps:

Searching a region where the robot entered previously on the map containing communication signal strength according to the historical traveling trace on the map containing communication signal strength cached in the robot when the robot detects communication disconnection with a server;

Planning a second route according to the region where the robot entered previously and current location of the robot;

Indicating traveling of the robot based on the planned second route.

Optionally, the robot may further detect the status of communication between the robot and the server is connected or not. The robot may detect the status of communication connection with the server periodically or irregularly. If it is detected that the status of communication connection with the server is disconnected, the robot may make self-rescue.

A first self-rescue method executed by the robot is as follows possibly: If the map containing communication signal strength is not stored in the robot, the robot returns toward the starting point based on the historical traveling trace stored therein.

A second self-rescue method executed by the robot is further as follows possibly: If the map containing communication signal strength is stored in the robot, the historical traveling trace of the robot is stored on the map containing communication signal strength. In this way, the robot may search the regions where it entered previously on the map containing communication signal strength based on its own historical traveling trace, and then compares communication signal strength of the regions where it entered previously, thus selecting out the region where communication signal strength is stronger than the preset threshold. And then, the second route is planned by route planning according to the communication signal strength of the selected regions and the current location of the robot. Finally, the robot travels based on the planned second route. The second self-rescue method executed by the robot is equivalent to the process in which route planning is implemented with its own location of the robot as the starting location and with the regions where it entered previously as the regions around the starting location. It is not repeated here.

In practical application, the above self-rescue methods executed by the robot may be both applied in the robot traveling process based on the route planned by itself, and to the robot traveling process based on the route planned by the server. The method for planning route for robot by the robot itself is not limited to the method for planning route provided by this disclosure and also may be the method for planning route in related technologies. Similarly, the method for planning route for robot by the server is not limited to the method for planning route provided by this disclosure and also may be the method for planning route in related technologies.

FIG. 8 is a block diagram of a device for planning route 800 illustrated according to an exemplary embodiment, of which the device 800 may be applied in a server, for example, a server 200 as shown in FIG. 1. As shown in FIG. 8, the device 800 may comprise:

a route planning request acquiring module 801, configured to acquire a route planning request sent by a requester side;

a route planning module 802, configured to plan a route corresponding to the route planning request in a region where communication signal strength is stronger than a preset threshold;

a sending module 803, configured to send the planned route to the requester side.

Optionally, the device further comprises:

a determining module configured to determine the region where communication signal strength is stronger than the preset threshold from the map containing communication signal strength.

Optionally, the device further comprises:

a parameter acquiring module configured to acquire a geographical location information of a geographical location where the requester side occurred and a communication signal strength of a corresponding geographical location;

a map building module configured to build the map containing communication signal strength and corresponding to the requester side in combination with the geographical location information and the communication signal strength;

wherein the determining module is configured to determine the region where communication signal strength is stronger than the preset threshold from the map containing communication signal strength and corresponding to the requester side.

Optionally, the communication signal strength comprises at least one of:

received signal strength indication RSSI, wireless network signal strength, and mobile data network signal strength.

Optionally, the parameter acquiring module further comprises:

a receiving submodule configured to receive detection results of communication signal strength sent by the requester side in each geographical location, wherein the detection results of communication signal strength contain a geographical location information of the geographical location where the requester side is located and communication signal strength of the corresponding geographical location.

As for the device in the embodiments above, specific operation modes executed by the modules thereof have been described specifically in the embodiments related to the method, thus it is not described in detail here.

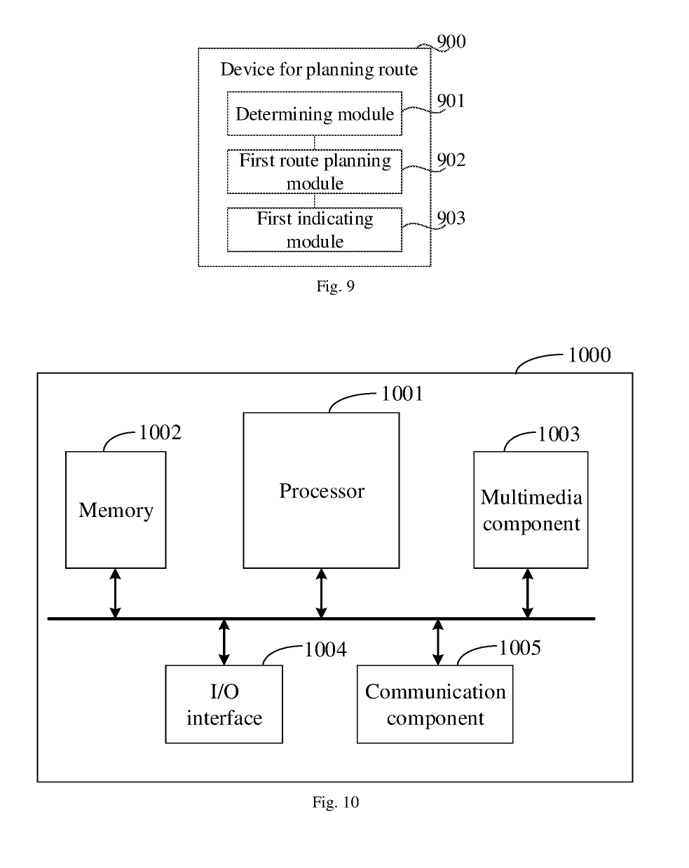

FIG. 9 is another block diagram of a device for planning route 900 illustrated according to an exemplary embodiment, of which the device 900 may be applied in a robot, for example, a requester side 100 as shown in FIG. 1. As shown in FIG. 9, the device 900 may comprise:

a determining module 901, configured to determine a region where communication signal strength is stronger than a preset threshold according to a map containing communication signal strength stored in the robot when the robot detects that communication signal strength in its own region is lower than the preset threshold;

a first route planning module 902, configured to plan a first route in the region where communication signal strength is stronger than the preset threshold;

a first indicating module 903, configured to indicate traveling of the robot based on the planned first route.

Optionally, the device further comprises:

a searching module configured to search the region where the robot entered previously on the map containing communication signal strength according to a historical traveling trace on the map containing communication signal strength cached in the robot when the robot detects communication disconnection with a server;

a second route planning module configured to plan a second route according to the region where the robot entered previously and current location of the robot;

a second indicating module configured to indicate the traveling of the robot based on the planned second route.

As for the device in the embodiments above, specific operation modes executed by the modules thereof have been described specifically in the embodiments related to the method, thus it is not described in detail here.

FIG. 10 is a further block diagram of the device for planning route 1000 illustrated according to an exemplary embodiment, and the device 1000 may be a server. As shown in FIG. 10, the device 1000 may include: a processor 1001, a memory 1002, a multimedia component 1003, an input/output (I/O) interface 1004, and a communication component 1005.

The processor 1001 is used for controlling the overall operation of the device 1000 to complete the whole or partial steps of the method for planning route above. The memory 1002 is used for storing various types of data to support the operation of the device 1000. For example, the data may include a command of any application program or method for the operation on the device 1000, and data related to the application program, such as contact data, sending/receiving messages, pictures, audio, video, etc. The memory 1002 may be implemented by any type of volatile or nonvolatile memory device or a combination thereof, such as, Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, disk or CD. The multimedia component 1003 may include a screen and an audio component. For example, the screen may be a touch screen, and the audio component is used for the output and/or input of audio signals. For example, the audio component may include a microphone used for receiving external audio signals. The received audio signals may be further stored in the memory 1002 or sent by the communication component 1005. The audio component further includes at least one loudspeaker used for the output of audio signals. The I/O interface 1004 provides an interface between the processor 1001 and each of other interface modules, and the other interface modules above may be a keyboard, a mouse, a button, etc. The button may be a virtual button or a real button. The communication component 1005 is used for the wire communication or wireless communication between the device 1000 and each of other equipment. Wireless communication, for example, Wi-Fi, Bluetooth, Near Field Communication (NFC), 2G, 3G or 4G, or one or more combinations thereof. Therefore, accordingly, the communication component 1005 may include: a Wi-Fi module, a Bluetooth module and a NFC module.

In an exemplary embodiment, the device 1000 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors or other electronic elements used for executing the method for planning route above.

In another exemplary embodiment, a computer program product is further provided, and the computer program product contains a computer program executed by a programmable device, and the computer program has a code portion for executing the method for planning route above when executed by the programmable device.

In a further exemplary embodiment, a non-transitory computer readable storage medium including commands is further provided, for example, the memory 1002 including commands, and the commands above may be executed by the processor 1001 of the device 1000 to complete the method for planning route above. Exemplarily, the non-transitory computer readable storage medium may be a ROM, a Random Access Memory (RAM), a CD-ROM, a tape, a floppy disk, an optical data memory device, etc.

In a further exemplary embodiment, a server is further provided, including a non-transitory computer readable storage medium; and one or more processors, used for executing programs in the non-transitory computer readable storage medium. The non-transitory computer readable storage medium stores a command for executing the method for planning route applied in the server above.

In a further exemplary embodiment, a robot is further provided, including: a traveling drive unit, a non-transitory computer readable storage medium; and one or more processors, used for executing programs in the non-transitory computer readable storage medium. The non-transitory computer readable storage medium stores a command for executing the method for planning route applied in the requester side above.

Preferred embodiments of this disclosure are described specifically in combination with the drawings above, but this disclosure is not limited to specific details of the embodiments above. Various simple variations may be made to the technical solutions of this disclosure within the scope of the technical idea of this disclosure, and these simple variations belong to the protection scope of this disclosure.

Moreover, it should be noted that the particular technical features described in the particular embodiments above may be combined in any suitable manner in a case of no contradiction. To avoid unnecessary repetition, any possible combination is not specified separately in this disclosure any more.

In addition, different embodiments of this disclosure may be combined in any manner, and any combination should be regarded as the content of this disclosure within the spirit of this disclosure.

1. A method for planning route, wherein the method is applied in a server and comprises:
acquiring a route planning request sent by a requester side;
planning a route corresponding to the route planning request in a region where communication signal strength is stronger than a preset threshold;
sending the planned route to the requester side.

2. The method according to claim 1, wherein before planning the route corresponding to the route planning request in the region where communication signal strength is stronger than the preset threshold, the method further comprises:
determining the region where communication signal strength is stronger than the preset threshold from a map containing communication signal strength.

3. The method according to claim 2, wherein the method further comprises:
acquiring a geographical location information of a geographical location where the requester side occurred and a communication signal strength of a corresponding geographical location;
building the map containing communication signal strength and corresponding to the requester side in combination with the geographical location information and the communication signal strength;
wherein the process of determining the region where communication signal strength is stronger than the preset threshold from the map containing communication signal strength comprises:
determining the region where communication signal strength is stronger than the preset threshold from the map containing communication signal strength and corresponding to the requester side.

4. The method according to claim 1, wherein the communication signal strength comprises at least one of:
received signal strength indication RSSI, wireless network signal strength, and mobile data network signal strength.

5. The method according to claim 3, wherein the process of acquiring the geographical location information of the geographical location where the requester side occurred and the communication signal strength of the corresponding geographical location comprises:
receiving detection results of communication signal strength sent by the requester side in each geographical location, wherein the detection results of communication signal strength contain a geographical location information of a geographical location where the requester side is located and communication signal strength of the corresponding geographical location.

6. A method for planning route, wherein the method is applied in a robot and comprises:
determining a region where communication signal strength is stronger than a preset threshold according to a map containing communication signal strength stored in the robot when the robot detects that communication signal strength in its own region is lower than the preset threshold;
planning a first route in the region where communication signal strength is stronger than the preset threshold;
indicating traveling of the robot based on the planned first route.

7. The method according to claim 6, wherein the method further comprises:
searching a region where the robot entered previously on the map containing communication signal strength according to a historical traveling trace on the map containing communication signal strength cached in the robot when the robot detects communication disconnection with a server;
planning a second route according to the region where the robot entered previously and current location of the robot;
indicating traveling of the robot based on the planned second route.

8.-15. (canceled)

16. A non-transitory computer readable storage medium, wherein the non-transitory computer readable storage medium stores one or more programs, and the one or more programs are used for executing the method according to claim 1.

17. A server, wherein the server comprises:
a non-transitory computer readable storage medium; and
one or more processors, used for executing a program in the non-transitory computer readable storage medium, wherein the non-transitory computer readable storage medium stores a command for executing the method according to claim 1.

18. A robot, wherein the robot comprises a traveling drive device, a non-transitory computer readable storage medium; and
one or more processors, used for executing a program in the non-transitory computer readable storage medium, wherein the non-transitory computer readable storage medium stores a command for executing the method according to claim 6.
